(19) United States
(12) Patent Application Publication
(10) Pub. No.: US 2024/0028362 A1
(43) Pub. Date: Jan. 25, 2024

(54) OBJECT VALIDATION IN SOFTWARE-DEFINED DATA CENTER SCRIPTS

(71) Applicant: VMware, Inc., Palo Alto, CA (US)

(72) Inventors: Branislav Abadzhimarinov, Sofia (BG); Martin Marinov, Sofia (BG)

(73) Assignee: VMware, Inc., Palo Alto, CA (US)

(21) Appl. No.: 17/871,454

(22) Filed: Jul. 22, 2022

(51) Int. Cl. G06F 9/455; G06F 9/54

(52) U.S. Cl. CPC G06F 9/45558; G06F 9/548; G06F 2009/45591

(57) ABSTRACT

A script for execution in a software-defined data center (SDDC) can be received. The script can include an object identifier of an SDDC resource object. A validation of the object identifier can be performed before the script is executed. The script can be executed responsive to the validation being successful. A notification can be provided responsive to the validation being unsuccessful.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may purchase data storage and/or data processing services from the provider in order to run applications that handle the enterprises' core business and operational data. The applications may be proprietary and used exclusively by the enterprise or made available through a network for anyone to access and use.

Virtual computing instances (VCIs) have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

### BRIEF DESCRIPTION OF THE DRAWINGS

FIG. 1 is a diagram of a host and a system for object validation in SDDC scripts according to one or more embodiments of the present disclosure.

FIG. 2 is a diagram of a method for object validation in SDDC scripts according to one or more embodiments of the present disclosure.

FIG. 3 is a diagram of a system for object validation in SDDC scripts according to one or more embodiments of the present disclosure.

FIG. 4 is a diagram of a system for object validation in SDDC scripts according to one or more embodiments of the present disclosure.

FIG. 5 is a diagram of a machine for object validation in SDDC scripts according to one or more embodiments of the present disclosure.

### DETAILED DESCRIPTION

The term “virtual computing instance” (VCI) covers a range of computing functionality, such as virtual machines, virtual workloads, data compute nodes, clusters, and containers, among others. A virtual machine refers generally to an isolated user space instance, which can be executed within a virtualized environment. Other technologies aside from hardware virtualization can provide isolated user space instances, also referred to as data compute nodes, such as containers that run on top of a host operating system without a hypervisor or separate operating system and/or hypervisor kernel network interface modules, among others. Hypervisor kernel network interface modules are data compute nodes that include a network stack with a hypervisor kernel network interface and receive/transmit threads. The term “VCI” covers these examples and combinations of different types of data compute nodes, among others.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs. While the present disclosure refers to VCIs, the examples given could be any type of virtual object, including data compute node, including physical hosts, VCIs, non-VCI containers, virtual disks, and hypervisor kernel network interface modules. Embodiments of the present disclosure can include combinations of different types of data compute nodes.

VCIs can be created in a public cloud environment. The term public cloud refers to computing services (hereinafter referred to simply as “services”) provided publicly over the Internet by a cloud service provider. One example of a cloud service provider is Amazon Web Services (AWS), though embodiments of the present disclosure are not so limited. A public cloud frond end refers to the user-facing part of the cloud computing architecture, such as software, user interface, and client-side devices. A public cloud backend refers to components of the cloud computing system, such as hardware, storage, management, etc., that allow the front end to function as desired. Some public cloud backends allow customers to rent VCIs on which to run their applications. Users can boot a VCI base image to configure VCIs therefrom. Users can create, launch, and terminate such VCIs as needed. Users can be charged, for example, for the time during which the VCI is in operation.

Resources (VCIs, datacenters, clusters, hosts, etc.) in an SDDC may be represented by domain objects (referred to herein simply as “objects”). Objects may be identified (e.g., referenced) by an object identifier (referred to herein simply as an “identifier”). Scripts may be executed in a virtual deployment. A script, as known to those of skill in the art, is a set of executable instructions. In various scripting and application programming interface (API) environments identifiers may be different. An example VCI may be identified in a public virtualized infrastructure manager (VIM) API by one identifier (e.g., vm-256), and the same VCI may be identified in a different scripting language known to those of skill in the art (e.g., PowerCLI, Python, Go, Bash, etc.) by a different identifier (e.g., VirtualMachine-vm-256). Identifiers are valid and unique in the scope of a single virtual deployment.

When executing scripts in a virtual environment, perhaps the most common causes of errors are invalid object identifiers. In some cases, this is caused by the script using identifiers that do not exist in the current deployment. In some cases, this is caused by the current user (e.g., the logged in user) not having permission to access one or more of the objects. Identifiers are commonly used as parameters to different API calls. When writing or generating a script, the deployment used may be different than the one against which the script is ultimately executed. As a result, an administrator may be needed to adjust the identifiers to the deployment on which the script is executed. Failing to do so leads to errors indicating that the referenced objects do not exist.

Scripts usually feature more than one API call. It is possible for some API calls in a script to succeed (e.g., be executed) and other API calls in the script to fail (e.g., not be executed). Therefore, if the administrator executes a script with two API calls and has adjusted the identifiers only for the first API call, then the first API call will succeed while the second will fail (e.g., error out). In such cases, the administrator may need to alter the script to execute only the second API call and adjust the object identifiers to match the deployment used to execute the script. This process may be time consuming and burdensome as the previously executed commands of the script need to be reverted along the way.

Embodiments of the present disclosure can validate object identifiers to ensure that they are valid in the environment and the context of the deployment in which the script is executed before actually executing the script, thereby reducing (e.g., eliminating) script errors. Embodiments herein are applicable in both command line interface (CLI) and user interface (UI) applications used to execute a script. In CLI environments, for example, embodiments herein can be initiated by passing a command line argument or incorporated in a predictive operation known to those of skill in the art (e.g., a —Whatif operation in PowerCLI). In a UI, embodiments herein can be initiated via a user input (e.g., a display toggle). If the script validation is successful because all the identifiers therein exist and the user has privileges to view them, then the script can be executed. If the script validation is unsuccessful because one or more of the identifiers therein do not exist at the time of the validation or if the user lacks privileges to view them, then the script may not be executed and a notification may be provided.

Previous approaches may provide syntactic validation on the executed script. In typed scripting languages, like PowerShell, for instance, type validation may be performed by using PowerCLI commandlets, for instance. However, previous approaches do not perform validation of object identifiers against the deployment where the script is going to be executed. Languages such as PowerCLI offer the commandlet implementer to incorporate some additional functionality in the —Whatif operation, but it is not a universal solution and requires additional work for each commandlet. Validation, as described by embodiments herein, is universal in the sense that it can be applied on top of a script without the need to implement support for it in each command.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

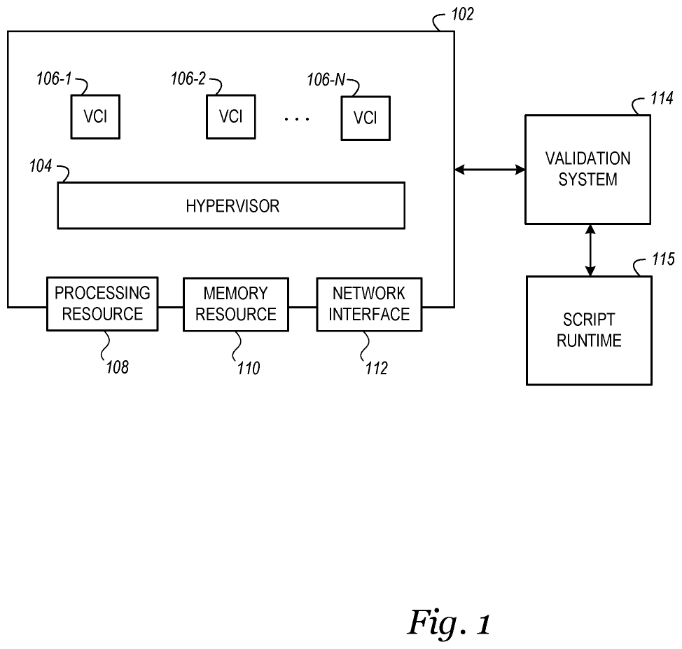

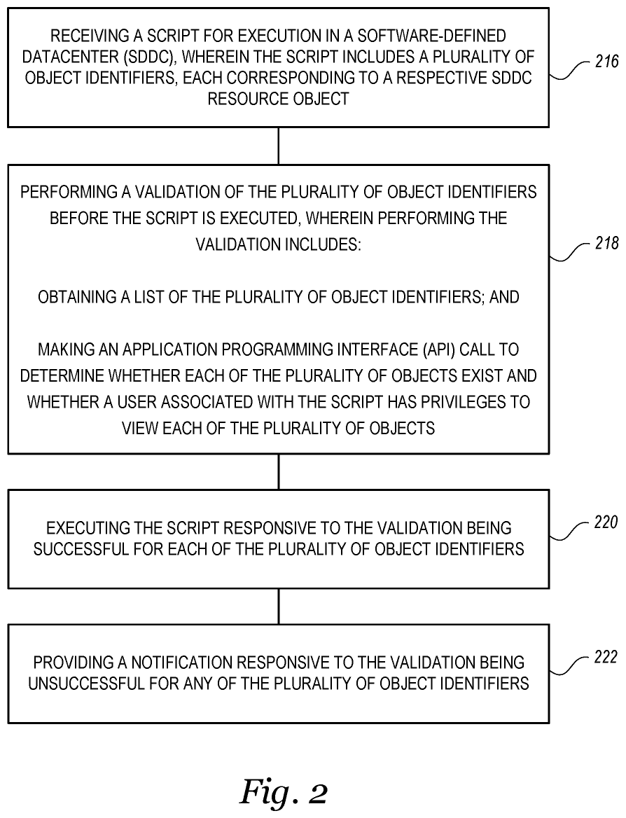

The figures herein follow a numbering convention in which the first digit or digits correspond to the drawing figure number and the remaining digits identify an element or component in the drawing. Similar elements or components between different figures may be identified by the use of similar digits. For example, 228 may reference element “28” in FIG. 2, and a similar element may be referenced as 928 in FIG. 9. Analogous elements within a Figure may be referenced with a hyphen and extra numeral or letter. Such analogous elements may be generally referenced without the hyphen and extra numeral or letter. For example, elements 116-1, 116-2, and 116-N in FIG. 1A may be collectively referenced as 116. As used herein, the designator “N”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 is a diagram of a host and a system for object validation in SDDC scripts according to one or more embodiments of the present disclosure. The system can include a host 102 with processing resources 108 (e.g., a number of processors), memory resources 110, and/or a network interface 112. The host 102 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

The host 102 can incorporate a hypervisor 104 that can execute a number of virtual computing instances 106-1, 106-2, . . . , 106-N (referred to generally herein as “VCIs 106”). The VCIs can be provisioned with processing resources 108 and/or memory resources 110 and can communicate via the network interface 112. The processing resources 108 and the memory resources 110 provisioned to the VCIs can be local and/or remote to the host 102. For example, in a software defined data center, the VCIs 106 can be provisioned with resources that are generally available to the software defined data center and not tied to any particular hardware device. By way of example, the memory resources 110 can include volatile and/or non-volatile memory available to the VCIs 106. The VCIs 106 can be moved to different hosts (not specifically illustrated), such that a different hypervisor manages the VCIs 106. The host 102 can be in communication with a validation system 114. An example of the validation system 114 is illustrated and described in more detail below. The validation system 114 can be in communication with a script runtime 115. The script runtime 115 can run (e.g., execute) scripts.

FIG. 2 is a diagram of a method for object validation in SDDC scripts according to one or more embodiments of the present disclosure. At 216, the method includes receiving a script for execution in an SDDC, wherein the script includes a plurality of object identifiers, each corresponding to a respective SDDC resource object. The script can be received from any suitable source. In some embodiments, the script is created via an application that records user interactions with a user interface and creates scripts corresponding to the interactions. Such applications are known to those of skill in the art, one example being referred to as “code capture.” The script can be executable via a user interface. The script can be executable vi a CLI.

At 218, the method includes performing a validation of the plurality of object identifiers before the script is executed. The validation, as referred to herein, can be performed responsive to different criteria. In some embodiments, the validation is performed responsive to a user input. For example, a user may indicate that validation before execution is desired by toggling a displayed switch. In some embodiments, the validation is performed responsive to a command line argument. In some embodiments, the validation is performed responsive to a predictive operation (e.g., a —Whatif operation). In some embodiments, the validation is performed responsive to an activation of a recording application (e.g., code capture). In some embodiments, the validation is performed responsive to receiving a command to execute the script (and before execution of the script).

Performing the validation can include obtaining a list of the plurality of object identifiers. Stated differently, all the identifiers used in the script, as well as the deployments they will be used in, can be obtained. Performing the validation can include making an API call to determine whether each of the plurality of objects exist. The API call can be made to a virtual server in which the script is to be executed.

Performing the validation can include determining whether a user associated with the script has privileges to view each of the plurality of objects. Stated differently, performing the validation can include determining whether all of the objects are visible to the caller in the respective deployments. Login credentials can be received from the user, and whether the user has privileges to view each of the plurality of objects can be determined based on the login credentials.

At 220, the method includes executing the script responsive to the validation being successful for each of the plurality of object identifiers. The validation being successful can include each of the identifiers in the script corresponding to existing objects that the user has privileges to view. Upon a successful validation, the script can be executed normally.

At 222, the method includes providing a notification responsive to the validation being unsuccessful for any of the plurality of object identifiers. In some embodiments determining that the validation was unsuccessful includes determining that the user lacks privileges to view any of the plurality of objects. In some embodiments, determining that the validation was unsuccessful includes determining that any of the plurality of object identifiers do not exist in the SDDC when the validation is performed.

In some embodiments, the differentiation regarding whether an object does not exist or whether a user executing the script lacks privileges may not be presented to that user. Stated differently, the particular reason for an unsuccessful validation may not be provided to the current user. However, in such embodiments, a “super administrator” with heightened privileges may be made aware of which cause was responsible for a failure. The super administrator may use this information to validate whether a given script can be run by another (e.g., less privileged) user, for instance.

Below is an example PowerCLI script to create a datacenter named “New Datacenter” in a vCenter deployment with ID bfdd1479-f621-4365-aefd-c1bb83f9db18:
$name=‘Datacenter’
$_this=Get-View-Id ‘Folder-group-d127’-Server (Get-VcConnection-VcInstanceUuid ‘bfdd1479-f621-4365-aefd-c1bb83f9db18’)
$_this.CreateDatacenter($name)

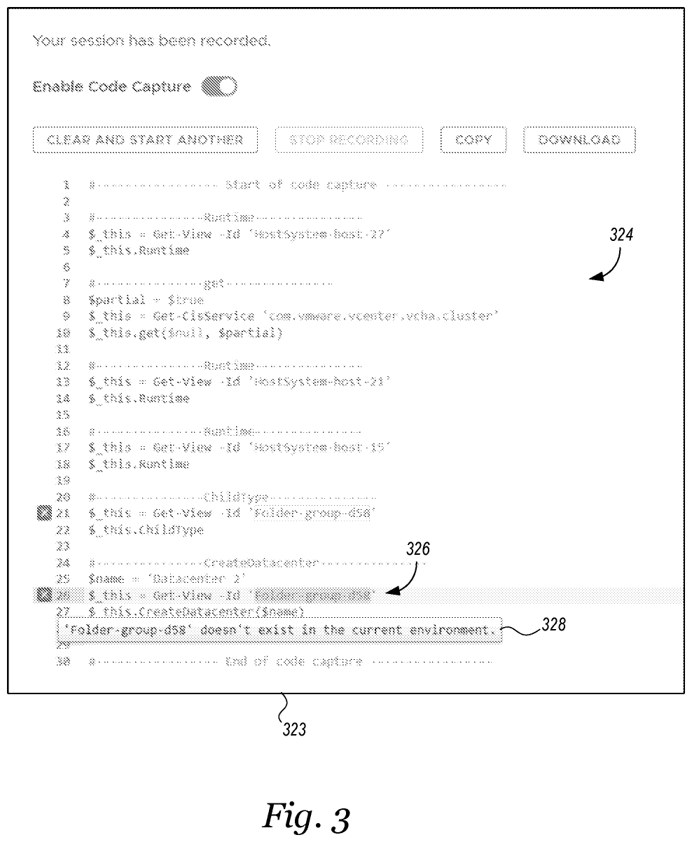

If a folder with identifier “Folder-group-d127” does not exist in the vCenter deployment with ID bfdd1479-f621-4365-aefd-c1bb83f9db18 then the user will receive a notification (e.g., an error) before executing the script. The provision of an example notification is discussed in more detail below in connection with FIG. 3.

FIG. 3 is an example display including a portion of a script and a notification according to one or more embodiments of the present disclosure. The display 323 can be a screen shot of a UI, for instance. The display 323 includes a portion of a script 324. As shown in FIG. 3, the script 324 includes an identifier 326 (“Folder-group-d58). A validation was performed and the identifier 326 was determined not to exist in the current environment. Accordingly, a notification 328 is provided on the display 323. In the example illustrated in FIG. 3, the notification 328 informs a user that the identifier 326 “doesn't exist in the current environment.” As shown in the example illustrated in FIG. 3, the notification 328 can be overlaid on the script 324 and can include a cause of the validation being unsuccessful (e.g., the object does not exist). A portion of the script 324 that corresponds to the unsuccessful validation (e.g., the identifier 326) can be highlighted using a particular color or other visual cue. It is noted that the display 323 illustrated in FIG. 3 is provided for purposes of example. Embodiments of the present disclosure are not limited to the particular appearance, layout, notification style, and/or other visual aspects of the particular example illustrated in FIG. 3.

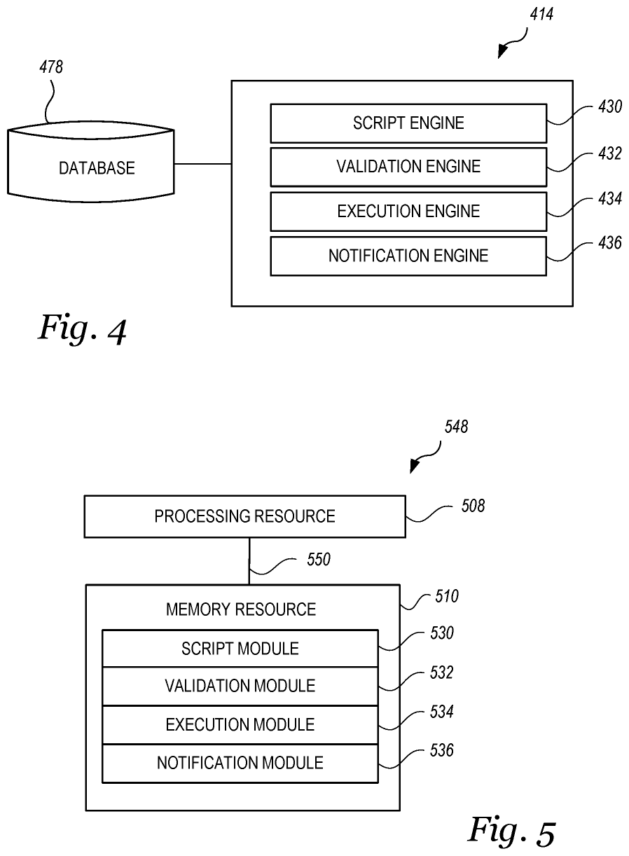

FIG. 4 is a diagram of a system 414 for object validation in SDDC scripts according to one or more embodiments of the present disclosure. The system 414 can include a database 478 and/or a number of engines, for example script engine 430, validation engine 432, execution engine 434, notification engine 436, and can be in communication with the database 478 via a communication link. The system 414 can include additional or fewer engines than illustrated to perform the various functions described herein. The system can represent program instructions and/or hardware of a machine (e.g., machine 548 as referenced in FIG. 5, etc.). As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, a field programmable gate array, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the script engine 430 can include a combination of hardware and program instructions that is configured to receive a script for execution in a software-defined datacenter (SDDC), wherein the script includes an object identifier of an SDDC resource object. In some embodiments, the validation engine 432 can include a combination of hardware and program instructions that is configured to perform a validation of the object identifier before the script is executed. In some embodiments, the execution engine 434 can include a combination of hardware and program instructions that is configured to execute the script responsive to the validation being successful. In some embodiments, the notification engine 436 can include a combination of hardware and program instructions that is configured to provide a notification responsive to the validation being unsuccessful.

FIG. 5 is a diagram of a machine 548 for object validation in SDDC scripts according to one or more embodiments of the present disclosure. The machine 548 can utilize software, hardware, firmware, and/or logic to perform a number of functions. The machine 548 can be a combination of hardware and program instructions configured to perform a number of functions (e.g., actions). The hardware, for example, can include a number of processing resources 508 and a number of memory resources 510, such as a machine-readable medium (MRM) or other memory resources 510. The memory resources 510 can be internal and/or external to the machine 548 (e.g., the machine 548 can include internal memory resources and have access to external memory resources). In some embodiments, the machine 548 can be a VCI. The program instructions (e.g., machine-readable instructions (MRI)) can include instructions stored on the MRM to implement a particular function (e.g., an action such as providing a notification, as described herein). The set of MRI can be executable by one or more of the processing resources 508. The memory resources 510 can be coupled to the machine 548 in a wired and/or wireless manner. For example, the memory resources 510 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

Memory resources 510 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media.

The processing resources 508 can be coupled to the memory resources 510 via a communication path 550. The communication path 550 can be local or remote to the machine 548. Examples of a local communication path 550 can include an electronic bus internal to a machine, where the memory resources 510 are in communication with the processing resources 508 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 550 can be such that the memory resources 510 are remote from the processing resources 508, such as in a network connection between the memory resources 510 and the processing resources 508. That is, the communication path 550 can be a network connection. Examples of such a network connection can include a local area network (LAN), wide area network (WAN), personal area network (PAN), and the Internet, among others.

As shown in FIG. 5, the MRI stored in the memory resources 510 can be segmented into a number of modules 530, 532, 534, 536 that when executed by the processing resources 508 can perform a number of functions. As used herein a module includes a set of instructions included to perform a particular task or action. The number of modules 530, 532, 534, 536 can be sub-modules of other modules. For example, the notification module 536 can be a sub-module of the execution module 534 and/or can be contained within a single module. Furthermore, the number of modules 530, 532, 534, 536 can comprise individual modules separate and distinct from one another. Examples are not limited to the specific modules 530, 532, 534, 536 illustrated in FIG. 5.

Each of the number of modules 530, 532, 534, 536 can include program instructions and/or a combination of hardware and program instructions that, when executed by a processing resource 508, can function as a corresponding engine as described with respect to FIG. 4. For example, the script module 530 can include program instructions and/or a combination of hardware and program instructions that, when executed by a processing resource 508, can function as the script engine 430, though embodiments of the present disclosure are not so limited.

The machine 548 can include a script module 530, which can include instructions to receive a script for execution in a software-defined datacenter (SDDC), wherein the script includes an object identifier of an SDDC resource object. The machine 548 can include a validation module 532, which can include instructions to perform a validation of the object identifier before the script is executed. The machine 548 can include an execution module 534, which can include instructions to execute the script responsive to the validation being successful. The machine 548 can include a notification module, which can include instructions to provide a notification responsive to the validation being unsuccessful.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A non-transitory machine-readable medium having instructions stored thereon which, when executed by a processor, cause the processor to:
receive a script for execution in a software-defined datacenter (SDDC), wherein the script includes an object identifier of an SDDC resource object;
perform a validation of the object identifier before the script is executed;
execute the script responsive to the validation being successful; and
provide a notification responsive to the validation being unsuccessful.

2. The medium of claim 1, wherein the instructions to perform the validation include instructions to:
obtain a list of the plurality of object identifiers; and
make an application programming interface (API) call to determine whether the object identifier exists and whether a user associated with the script has privileges to view the object.

3. The medium of claim 2, wherein the user associated with the script is a current user when the script is to be executed.

4. The medium of claim 1, including instructions to determine that the validation was unsuccessful responsive to:
a determination that the object identifier does not exist in the SDDC when the validation is performed; or
a determination that the user lacks privileges to view the resource object.

5. The medium of claim 1, wherein the script is to be executed via a user interface.

6. The medium of claim 1, wherein the script is to be executed via a command line interface.

7. The medium of claim 6, including instructions to perform the validation responsive to a command line argument.

8. The medium of claim 6, including instructions to perform the validation responsive to a predictive operation.

9. The medium of claim 1, wherein the script is created via an application that records user interactions with a user interface and creates scripts corresponding to the interactions.

10. The medium of claim 9, including instructions to perform the validation responsive to an activation of the application.

11. The medium of claim 9, including instructions to perform the validation responsive to receiving a command to execute the script.

12. A method, comprising:
receiving a script for execution in a software-defined datacenter (SDDC), wherein the script includes a plurality of object identifiers, each corresponding to a respective SDDC resource object;
performing a validation of the plurality of object identifiers before the script is executed, wherein performing the validation includes:
obtaining a list of the plurality of object identifiers; and
making an application programming interface (API) call to determine whether each of the plurality of objects exist and whether a user associated with the script has privileges to view each of the plurality of objects;
executing the script responsive to the validation being successful for each of the plurality of object identifiers; and
providing a notification responsive to the validation being unsuccessful for any of the plurality of object identifiers.

13. The method of claim 12, wherein the method includes performing the validation responsive to a user input.

14. The method of claim 12, wherein the method includes receiving login credentials from the user and determining whether the user has privileges to view each of the plurality of objects based on the login credentials.

15. The method of claim 12, wherein the method includes making the API call to a virtual server in which the script is to be executed.

16. The medium of claim 1, wherein the method includes determining that the validation was unsuccessful responsive to:
determining that any of the plurality of object identifiers do not exist in the SDDC when the validation is performed; or
determining that the user lacks privileges to view any of the plurality of SDDC resources.

17. A system, comprising:
a script engine configured to receive a script for execution in a software-defined datacenter (SDDC), wherein the script includes an object identifier of an SDDC resource object;
a validation engine configured to perform a validation of the object identifier before the script is executed;
an execution engine configured to execute the script responsive to the validation being successful; and
a notification engine configured to provide a notification responsive to the validation being unsuccessful.

18. The system of claim 17, wherein the notification engine is configured to display the notification overlaid on the script.

19. The system of claim 18, wherein the notification engine is configured to include, in the notification, a cause of the validation being unsuccessful.

20. The system of claim 19, wherein the notification engine is configured to highlight a portion of the script corresponding to the unsuccessful validation.
